(19) United States
(12) Patent Application Publication
(10) Pub. No.: US 2015/0119147 A1
(43) Pub. Date: Apr. 30, 2015

(54) TIME LIMITED, APPLICATION SPANNING AND POST-APPLICATION RELEASE ACHIEVEMENTS

(71) Applicant: Microsoft Corporation, Redmond, WA (US)

(72) Inventors: Steve Dolan, Redmond, WA (US); Chandler Holbrook, Lynnwood, WA (US); Micheal Dunn, Seattle, WA (US); Sean Haneberg, Seattle, WA (US)

(73) Assignee: Microsoft Corporation, Redmond, WA (US)

(21) Appl. No.: 14/063,219

(22) Filed: Oct. 25, 2013

(51) Int. Cl. A63F 13/30

(52) U.S. Cl. CPC A63F 13/12
USPC 463/42

(57) ABSTRACT

A cloud-based achievement and reward recognition portal exposes services that enable developers of games and other applications to author rules that govern the logging of player statistics that reflect a player's interactions and behaviors during gameplay. The logged player statistics are stored in a data repository and monitored by a service. The portal enables achievements to be authored that specify thresholds or other criteria for earning an achievement and obtaining an associated reward. When the monitoring of the player statistics indicates that a threshold has been crossed, a service will award the achievement to the player. A reward associated with the earned achievement can be provided to the player or unlocked within the game context.

### BACKGROUND

Achievements are typically authored by developers at game application development time and achievement-specific code is used inside of the application in order to signal to the entertainment platform on which the game runs that the user has earned an achievement. While such achievement-specific code works satisfactorily in many situations to provide more enriching game experiences to players through achievements, it can limit the game application owner or the platform owner from using an achievement's targeted behavior to shape user behavior after the original acquisition of the achievement by the user. That is, after the player earns the achievement, it is no longer able to shape the player's behavior.

Achievement-specific code also makes it difficult for achievements to drive user behavior across multiple applications executing on the entertainment platform. Application boundaries typically necessitate detailed collaboration between the application developers which can thus limit cross-application achievement experiences to be authored and implemented. Such limitations may further compound the difficulties in attempting to incentivize users to consume given pieces of media content (e.g., television shows, movies, music, games, etc.) through achievements. In order to properly award the achievement, every media content provider on the platform would generally need to author achievement-specific code to award the achievement to the player when it is earned. Developers are also unable to simply reuse achievements, change achievement requirements, or create new achievements after a product is released and shipped without changing the achievement-specific code.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A cloud-based achievement and reward recognition portal exposes services that enable developers of games and other applications to author rules that govern the logging of player statistics that reflect a player's interactions and behaviors during gameplay. The logged player statistics are stored in a data repository and monitored by a service. The portal enables achievements to be authored that specify thresholds or other criteria for earning an achievement and obtaining an associated reward. When the monitoring of the player statistics indicates that a threshold has been crossed, a service will award the achievement to the player. A reward associated with the earned achievement can be provided to the player or unlocked within the game context.

The achievement and reward recognition portal advantageously enables the achievement authoring to be disassociated from the code development of the application which can reduce or eliminate the use of achievement-specific code in some cases. The disassociation of achievement authoring from code development in the underlying application also means that player behaviors can be shaped through achievements that are authored after the application is developed and released. In addition, achievements can be authored through the portal for implementation that span application titles across diverse computing platforms such as multimedia players, personal computers (“PCs”), smartphones, and tablet computers. As application and game titles can have a long lifespan, such behavior shaping enables a title to be continuously updated and kept fresh to improve the quality of the user experience it provides. By offering new and compelling achievement challenges through the portal after a game has been released, players are incentivized to continue to participate in the game so that they can take part in the rich achievement experiences. For example, this continued participation can be beneficial to players of multi-player games where attracting and maintaining a minimum number of concurrent users is important to ensure the quality of gameplay.

In various illustrative examples, the achievement and reward recognition portal can expose achievement authoring tools and services to enable users to author a variety of achievements offering different experiences. These include cross-title achievements, cross-platform achievements, post-application release achievements, community achievements, social achievements, time window achievements, and meta-game achievements. The achievement and reward recognition portal can further provide achievement status data to a computing platform that can render a user interface (“UI”) on a computing platform that shows a player's progress towards completing one or more achievements.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure.

### DESCRIPTION OF THE DRAWINGS

FIG. 1 shows an illustrative cloud-computing environment in which the present time limited, application spanning, and post-application release achievements may be implemented;

FIG. 2 shows a game that is played in a cloud-computing environment;

FIG. 3 shows various services exposed by an achievement and reward configuration portal;

FIG. 4 is a flowchart of an illustrative method by which a developer, at the time of development of an application or game title authors rules for player statistics;

FIG. 5 shows various illustrative player statistics-based achievement experiences that may be authored;

FIG. 6 shows an illustrative player statistics logging client that resides on a computing platform such as a multimedia console;

FIG. 7 is flowchart of an illustrative method by which the present time limited, application spanning, and post-application release achievements may be implemented;

FIG. 8 shows an illustrative arrangement in which logged player statistics signals are sent to an achievement trigger service;

FIG. 9 shows an illustrative user interface that may be rendered on a computing platform such as a multimedia console which shows status of achievements being sought by a user;

FIG. 10 is an illustrative functional block diagram of a multimedia console;

FIG. 11 is a simplified block diagram of an illustrative computer system such as a personal computer (“PC”) that may be used in part to implement the present time limited, application spanning, and post-application release achievements; and

FIG. 12 shows a block diagram of an illustrative computing platform that may be used in part to implement the present time limited, application spanning, and post-application release achievements.

Like reference numerals indicate like elements in the drawings. Elements are not drawn to scale unless otherwise indicated.

### DETAILED DESCRIPTION

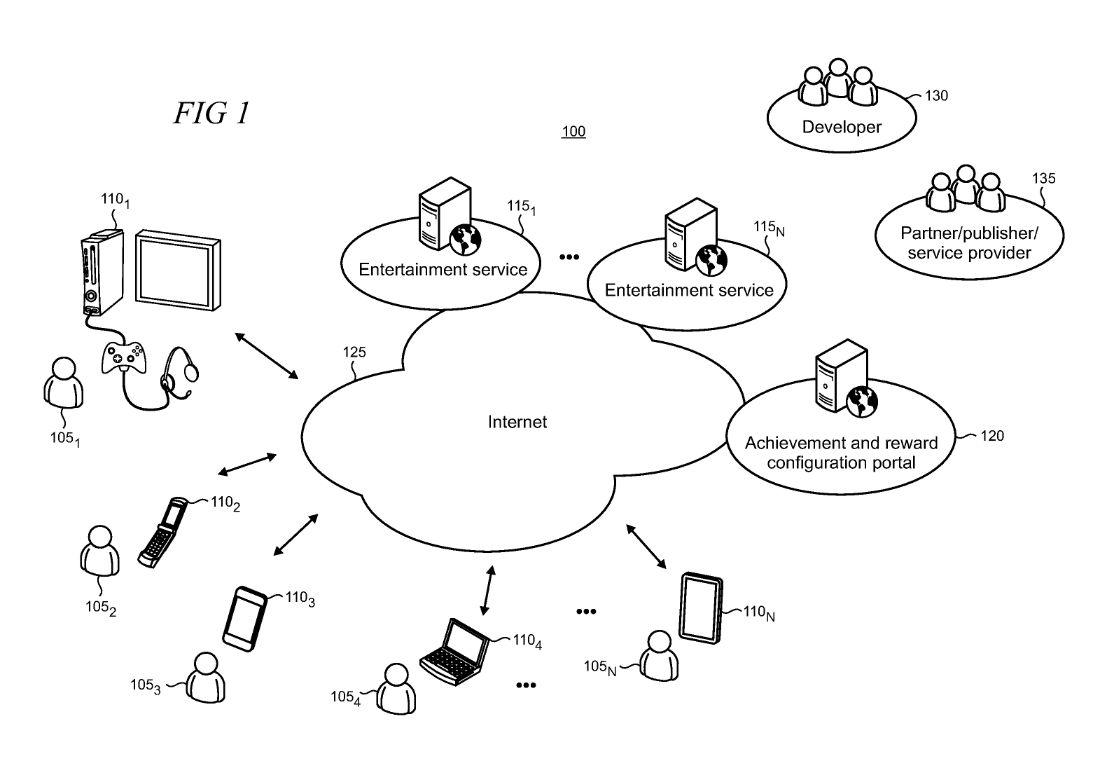

FIG. 1 shows an illustrative cloud-computing environment 100 in which the present time limited, application spanning, and post-application release achievements may be implemented. Users 105 of a variety of client computing platforms 110 such as multimedia consoles, mobile phones, smartphones, tablets, personal computers (“PCs”), personal digital assistants (“PDAs”), handheld gaming platforms, personal media players, wearable computers, navigation devices, and the like, which can consume and/or render media content may interact with one or more entertainment services 115_{1 . . . N} as well as an achievement and rewards configuration portal 120 over a network such as the Internet 125. In some implementations, an entertainment service 115 and the achievement and rewards configuration portal 120 may be combined into a common service or platform. The achievement and rewards configuration portal 120 may also be incorporated into an achievement system or service in some cases. As shown in FIG. 1, a developer 130 is also present in the cloud-computing environment 100. Various other partners (e.g., partners with the provider of the achievement and rewards configuration portal and/or entertainment service provider), publishers, and/or service providers may also be present in the cloud-computing environment 100 as representatively indicated by reference numeral 135.

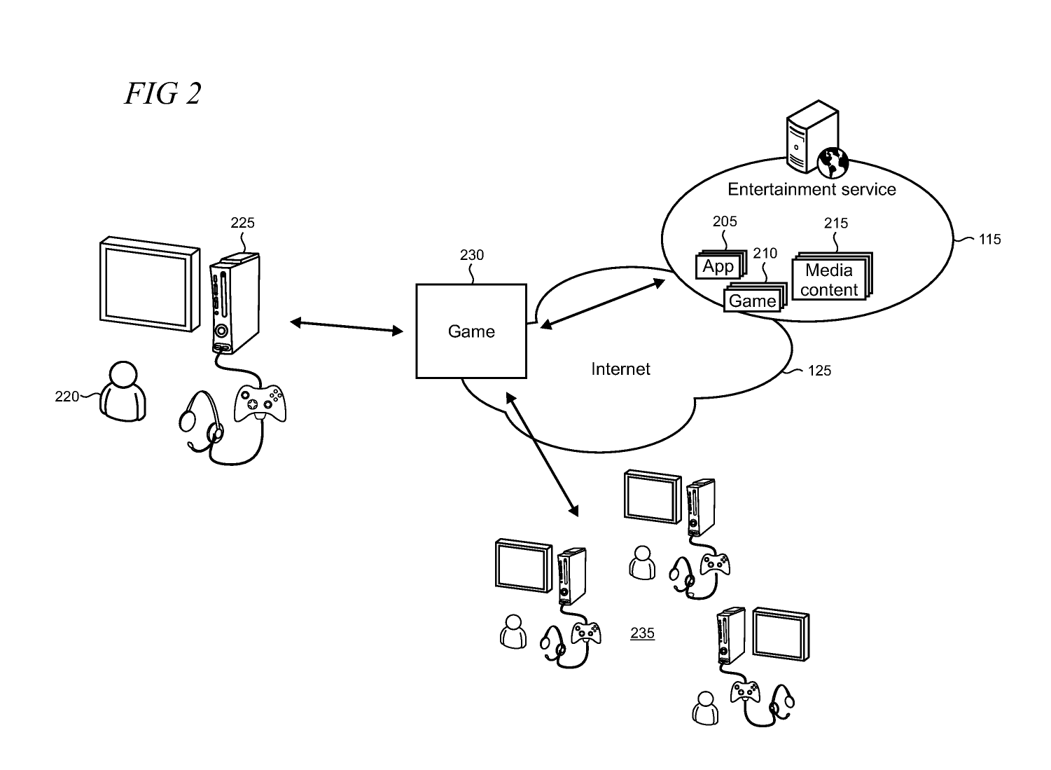

As shown in FIG. 2, an entertainment service 115 can typically expose applications (“apps”) 205, games 210, and media content 215 to a player 220 of a multimedia console 225. It will be appreciated that games may be viewed as a particular type of app. Thus, the term “app” is generally used in the description that follows to refer to non-game applications.

In an illustrative example shown in FIG. 2, the user plays a particular game 230. The game 230 may execute locally on the multimedia console, be hosted remotely by the entertainment service 115, or use a combination of local and remote execution in some cases. The game 230 may also be one in which multiple other players 235 can participate. It will be appreciated that multi-player gaming is often typically supported on other computing platforms such as smartphones and PCs. In addition, while this illustrative example deals with a gaming scenario, the present time limited, application spanning, and post-application release achievements can also be applied to apps 205 such as video and music applications. Accordingly, the use of the term “player” here can also be understood to refer to a user of such non-gaming applications.

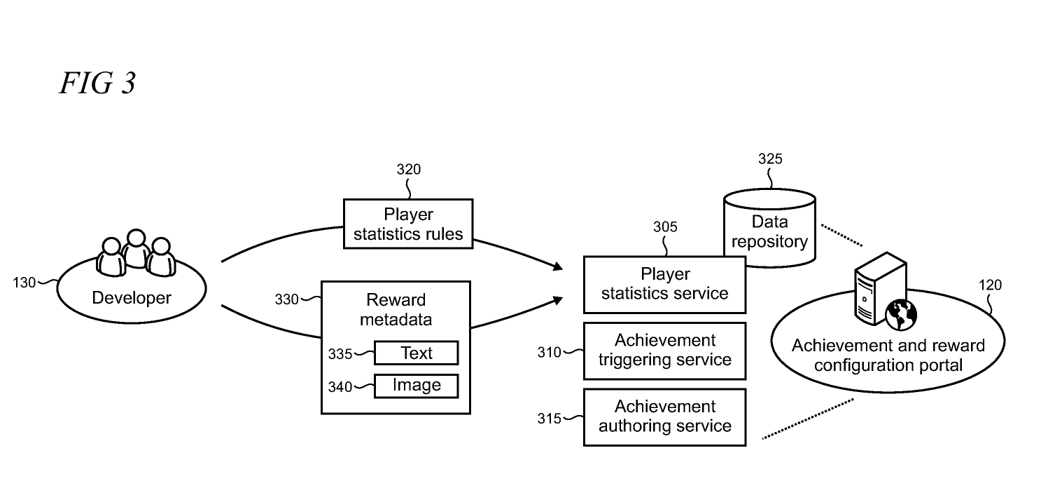

The achievement and reward configuration portal 120 is configured to expose a number of services, as shown in FIG. 3, including a player statistics service 305, an achievement triggering service 310, and an achievement authoring service 315. The services can be implemented as web services in some implementations. Typically, the developer 130 can interact with the player statistics service 305. The developer 130, in this illustrative example, is an entity that produces an application, game, or media content typically by generating software code that can execute in the cloud-computing environment 100 (FIG. 1) to create a user experience of some kind such as playing a game, consuming media content, interacting with other users, etc.

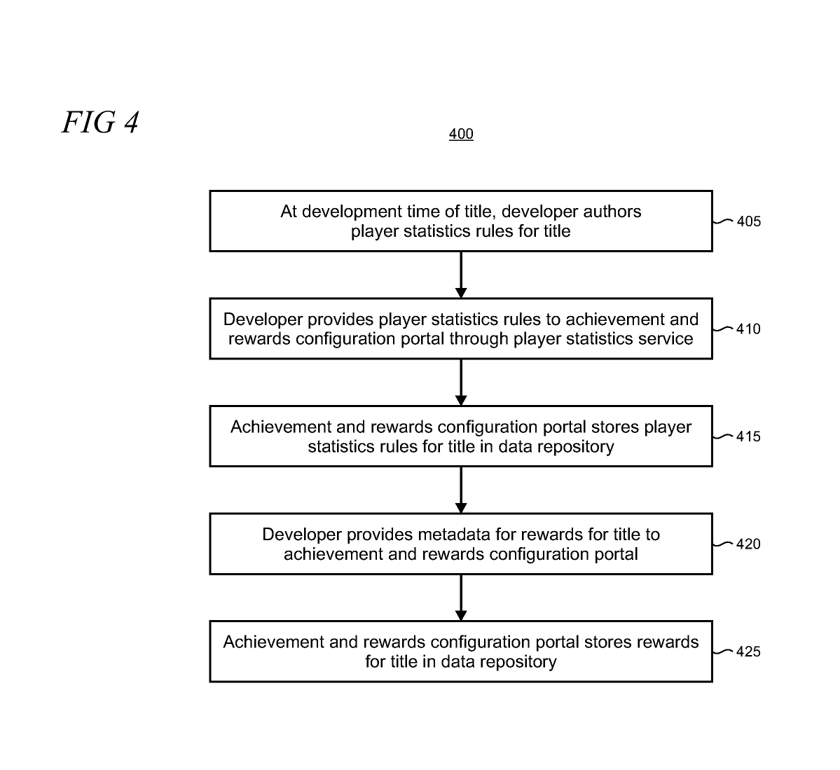

FIG. 4 is a flowchart of an illustrative method 400 by which the developer 130 authors rules for player statistics. The term “title” refers to a particular instance of a game or app. The method 400 refers to the elements shown in FIG. 3. Unless specifically stated, the methods or steps shown in the flowchart and described below are not constrained to a particular order or sequence. In addition, some of the methods or steps thereof can occur or be performed concurrently and not all the methods or steps have to be performed in a given implementation depending on the requirements of such implementation. Some methods or steps may be also optionally utilized.

At step 405 in the method, for a given app or game title, the developer 130 will author rules 320 for player statistics at the time of development of that title. The rules 320 typically describe events of interest that can occur during runtime of the title in the cloud-computing environment 100 (FIG. 1). The rules 320 and the events of interest can typically be expected to vary by title according to design choices made by the developer 130 in many cases. For example, a game developer may author rules that describe various player actions that can be expected to occur during gameplay. As described in more detail below, statistics about the player's behavior that conform to the developer's rules during gameplay can then be logged and analyzed to determine when achievements have been earned.

At step 410, the developer 130 will provide the player statistics rules 320 to the achievement and rewards configuration portal 120 through the player statistics service 305. The portal stores the player statistics rules in a data repository 325 at step 415. Typically, the developer 130 can also provide reward metadata 330 to the achievement and rewards configuration portal 120, at step 420 of the method, either using the player statistics service or through another interface to the portal 120 which is stored in the data repository at step 425. The reward metadata 330 may include descriptive text 335 for one or more rewards as well as an associated image 340, for example a JPEG (Joint Photographic Experts Group) image. Thus, for example, later on during gameplay, if analysis of logged player statistics shows that the player 220 earns an achievement by shooting 10 zombies in the game 230, the reward for the achievement might be a special zombie-neutralizing potion. An image of that particular reward and its description can be rendered on the user interface (“UI”) of the multimedia console 225 using the stored metadata 330 from the data repository.

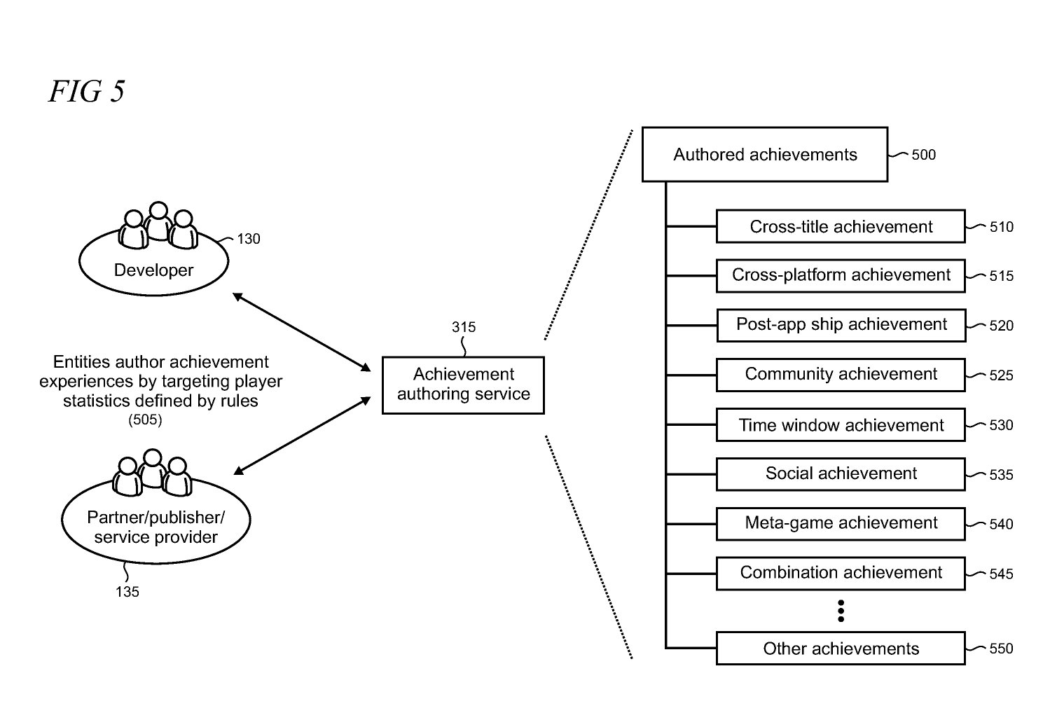

FIG. 5 shows a taxonomy of various illustrative player statistics-based achievements 500 that may be authored using the achievement authoring service 315 that is exposed by the achievement and rewards configuration portal for implementation during gameplay. As indicated by reference numeral 505 in FIG. 5, entities including the developer 130 and/or partner/publisher/service provider 135 can author an achievement experience by targeting particular player statistics that are defined by the rules 320. Alternatively, the achievement and rewards configuration portal 120 could be configured to expose the achievement authoring service to other entities, including, for example, members of the public where authoring achievements and challenges can be incorporated as a part of gameplay or app experience. For the sake of simplicity and convenience of the reader in the description of the various achievement experiences that follows, only the developer 130 is referred to as utilizing the achievement authoring service 315. However it may be understood that the achievement authoring service is not necessarily limited to only the developer's use.

As shown, the taxonomy includes cross-title achievement 510. The achievement triggering service 310 (as described in more detail below) is typically configured to monitor player statistics logged from multiple different games/apps at the same time. Therefore, the developer 130 can author achievements that span multiple titles. For example, a cross-title achievement 510 can be authored in which a player may earn an achievement and receive a reward for neutralizing 10 zombies across five different game titles featuring zombies. Similarly, the developer 130 can author a cross-title achievement in which a user earns an achievement and receives a reward for watching a total of 10 action movies regardless of the particular media rendering apps that the user may utilize to do the watching.

The developer 130 may interact with the achievement authoring service 315 to author a cross-platform achievement 515, for example to promote companion experiences on other computing platforms. Here, player statistics are logged and monitored across different computing platforms 110 (FIG. 1) that may be in the cloud-computing environment 100. For example, a player might neutralize five zombies in a game that runs on a tablet computer and neutralize another five zombies in a version of the game that runs on a PC, and thus qualify for an achievement and award in which 10 zombies need to be neutralized without regard to the computing platform used to perform the needed actions.

Achievements may advantageously be created after a title is shipped (i.e., released for use to the general public). For example, the developer 130 may author a post-app ship achievement 520 to promote a new television show that is produced and released after a media rendering app was released for a given computing platform. The user could receive an award for being a “True Fan” if all the episodes of the new show are watched, for example.

The developer 130 may author a community achievement 525 in which an entire community of players is given a goal to reach the achievement and unlock a previously locked reward. The community could include, for example, subscribers to a particular online service (e.g., Microsoft Corporation's branded Xbox Live online multiplayer gaming and media content delivery service), members of an online forum, or players who are otherwise part of an identifiable group. A community achievement 525 could include, for example, a challenge authored by the developer 130 for the community as whole to drive a million miles in a racing game. Once the community has achieved this goal, a reward is unlocked for each of the individuals in the community. In some cases, the community achievement could also have individual goals in addition to the community goal in order for the achievement to be reached and the reward unlocked for an individual player. For example, the developer 130 could author the community achievement so that the community goal is to drive a million miles in the racing game but each individual player needs to drive at least 1,000 in order to earn the achievement.

A time window achievement 530 may be authored by the developer 130 so that it is only available to be earned within a limited time window. For example, a time window achievement 530 may have a goal of neutralizing 100 zombies over an upcoming weekend. In order for the player to reach the achievement and receive a reward, the goal would need to be completed before the expiration of the limited time window.

The developer 130 can author a social achievement 535 in which a player is given a goal for an achievement that may be accomplished with the help of a friend (i.e., another player in the computing environment 100 who has some relationship with the player, either informally or formally through a social networking service or app, for example). The social achievement 535 can be scaled, in some cases dynamically, based on the amount of social participation, for example, or the size of the player's social graph. The achievement's goals may be authored in a way so that they become easier to achieve with more social participation. So, the social achievement's goal could be neutralizing 100 zombies with a party of friends where the collective zombie count is credited to each member of the party in earning an achievement and gaining a reward.

The meta-game achievement 540 may be authored by the developer 130 so that a goal of the achievement is earning a series of constituent achievements. For example, the meta-game achievement could include a player earning each of a “Played a New Game” achievement, a “Watched a New Show” achievement, and a “Listened to a New Song” achievement to then win yet another achievement, the meta-game achievement, the “Played-Watched-Listened” achievement.

The developer may also author a combination achievement 545 that utilizes various combinations of the achievement experiences described above. For example, a combination achievement can be authored with aspects of a post-app ship achievement and community achievement in which starting 90 days after a racing game is publicly released members of an online community need to drive a total of a million miles to earn an achievement and receive an award. Another example is a combination of aspects of a post-app ship achievement, a time window achievement, and a social achievement—beginning 90 days after a zombie hunting game is publicly released and ending a week later, every member of a player's party will receive credit for all zombies successfully neutralized beyond 100. Another example is a combination of aspects of a post-app ship achievement, cross-title achievement, and time window achievement—during the weekend beginning 30 days after the application is shipped in a release, an achievement can be earned for watching all of the movies in a crime drama series using any media rendering app on any computing platform. Other achievements 550 of various types may also be enabled for authoring through the achievement authoring service 315.

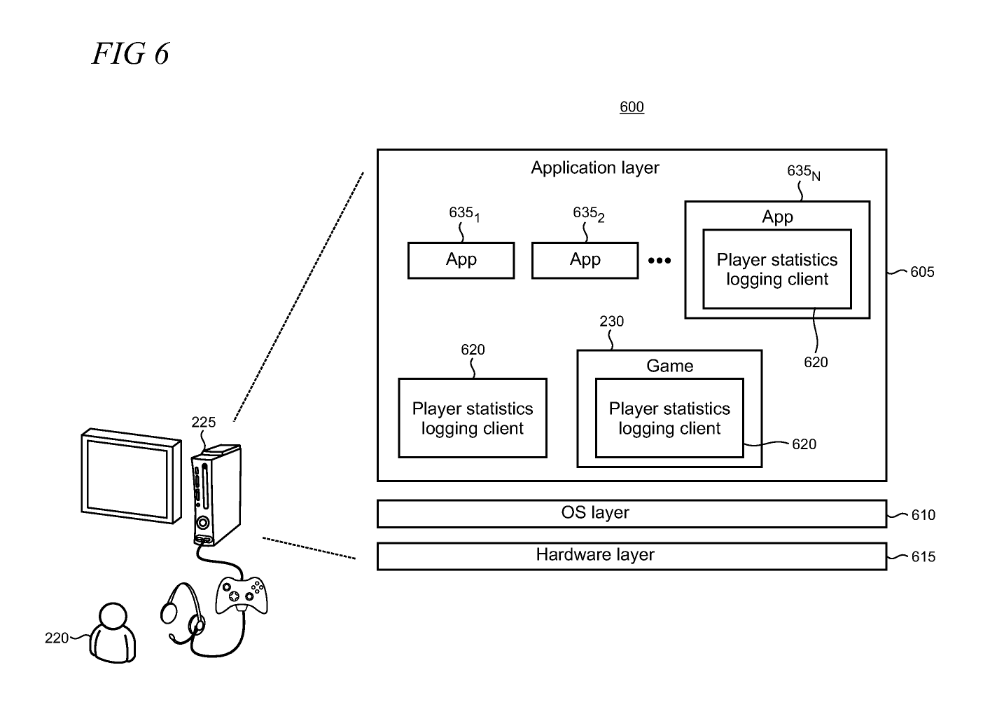

FIG. 6 shows an illustrative architecture 600 for functional components that may be instantiated on a client computing platform such as the multimedia console 225. The architecture 600 is typically implemented in software, although combinations of software, firmware, and/or hardware may also be utilized in some cases. The architecture 600 is arranged in layers and includes an application layer 605, an OS (operating system) layer 610, and a hardware layer 615. The hardware layer 615 provides an abstraction of the various hardware used by the computing platform (e.g., input and output devices, networking hardware, etc.) to the layers above it.

As shown in FIG. 6, the application layer 605 supports a variety of native applications 635_{1, 2 . . . N} that are generally implemented using locally executing code for the most part. In some cases, however, the native applications 635 may also rely on services and/or remote code execution provided by remote servers. The application layer 605, in this example, supports a player statistics logging client 620 that captures the statistics that are generated during the player's interaction with the game 230 and sends them to the achievement and reward configuration portal 120. The player statistics are typically implemented to be representative of a user's actions, inputs, behaviors, and the like that occur during gameplay so that the interaction can be subsequently compared against achievement criteria and thresholds to determine achievement and reward eligibility. The logging of player statistics is typically performed in an anonymized manner so that no personally identifiable information associated with the player is revealed to the services exposed by the portal. In addition, the logged player statistics are only utilized for determining achievement eligibility to improve the quality of gameplay and to enhance associated user experiences.

The player statistics logging client 620 may be instantiated as a standalone component and/or be incorporated within an app 635 or the game 230 which also typically resides in the application layer 605. Alternatively, the player statistics logging client may be distributed across multiple components in the application layer 605. While the player statistics logging client 620 resides in the application layer 605 in this illustrative example, in alternative arrangements the player statistics logging client 620 may be incorporated in various components in the OS layer 610 or hardware layer 615, or its functionality distributed across two or more layers in the architecture 600.

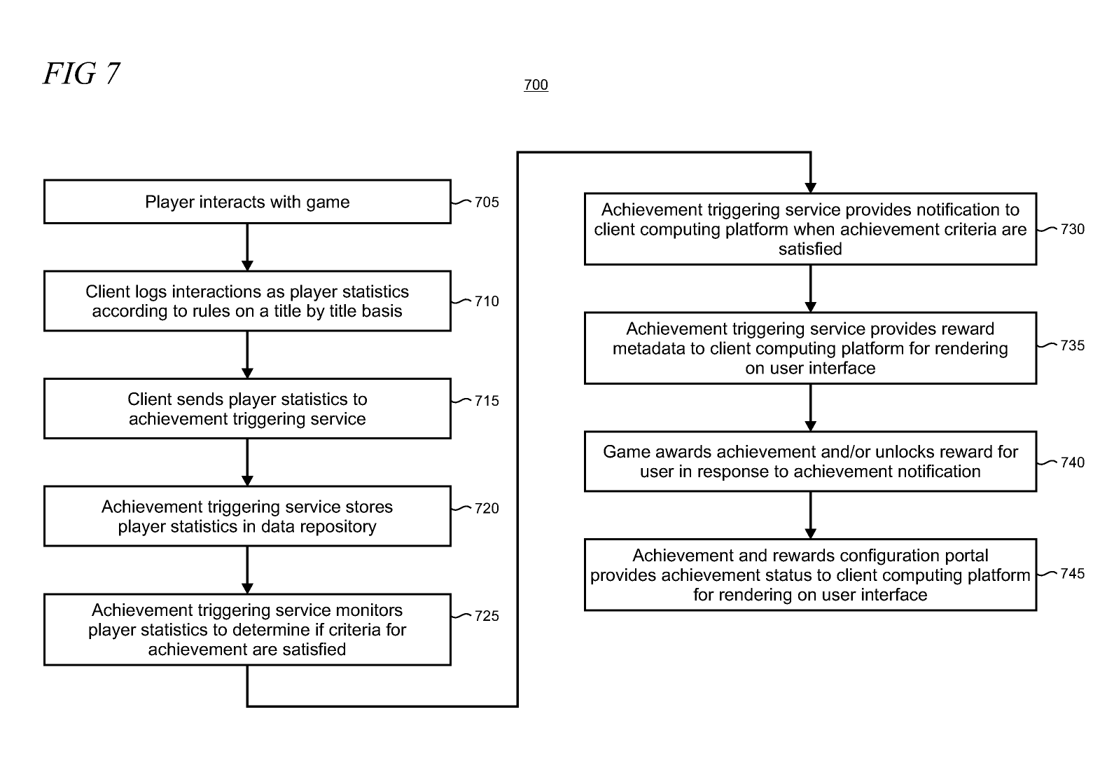

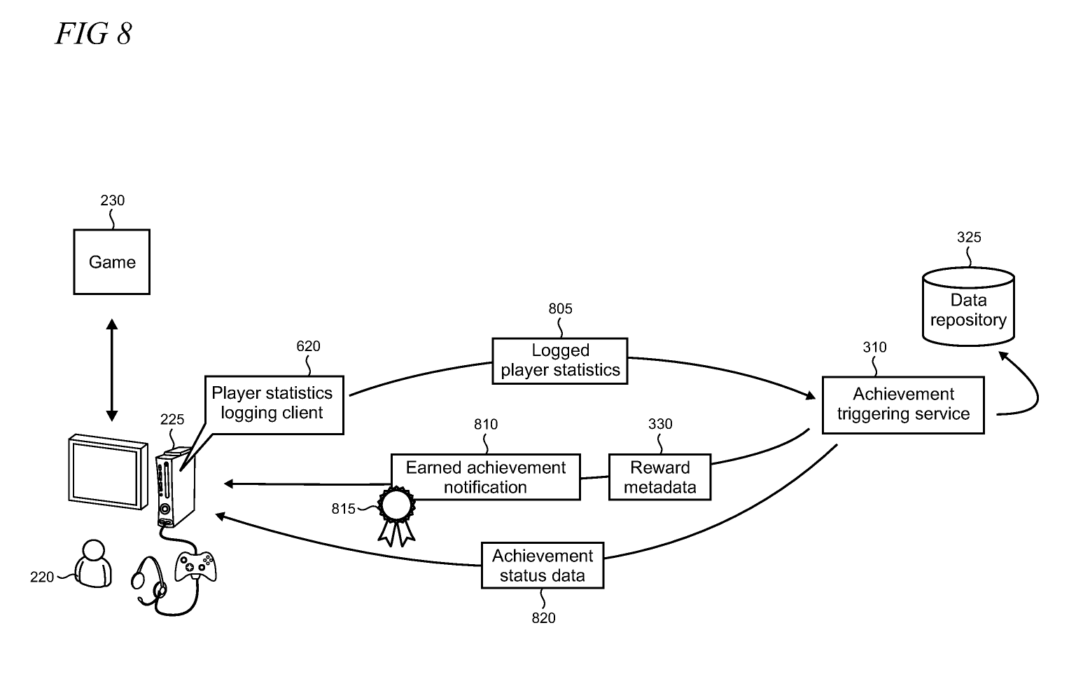

FIG. 7 is a flowchart of an illustrative method 700 by which achievements authored through the achievement authoring service 315 can be implemented during gameplay or runtime of an app. The method 700 refers to the elements shown in FIG. 8. At step 705 in the method, as the player 220 interacts with the game 230 on the multimedia console 225, the player statistics logging client 620 logs the user events specified by the developer's rules 320 (FIG. 3) at step 710 to generate player statistics 805. The logging is performed on a title-by-title basis. At step 715, the player statistics logging client 620 sends the player statistics 805 for the game to the achievements and rewards configuration portal through the achievement triggering service 310 which stores the player statistics to the data repository 325 at step 720.

At step 725, the achievement triggering service monitors the player statistics logged by the client 620 to determine if criteria in an authored achievement 500 (FIG. 5) have been met for the player to earn the achievement and receive a reward. At step 730, if the achievement triggering service 310 sees that an achievement has been earned, then it generates an earned achievement notification 810 which it sends, along with reward metadata 330 applicable to a reward 815 that is associated with the earned achievement at step 735. The reward metadata 330 may be rendered in a UI displayed on the multimedia console 225 so that the player 220 can see an image and text description of the reward 815 that is earned by completing the achievement.

Rewards that may be given for an earned achievement can vary by implementation and span the range from virtual rewards to actual physical rewards. The virtual rewards can be implemented inside and outside the context of the game 230. For example, an in-game reward could include special powers or capabilities, game objects, extra “lives,” additional game levels, virtual currency, updates to player avatars, and the like that are unlocked within the game context when an achievement is earned. Out-of-game rewards could include a Gamerscore in the context of Microsoft Corporation's Xbox, virtual coupons, media content such as music and videos, games, event tickets, and the like. Physical rewards may range from stickers to automobiles as the achievement author may deem appropriate. As with the present achievements, rewards may be implemented across titles, platforms, and player communities. In some implementations, additional systems and services beyond those shown in the cloud-computing environment 100 in FIG. 1 can be used to deliver and/or physically fulfill rewards.

In response to the earned achievement notification 810, the game 230 will award the achievement and grant or unlock the associated reward 815 at step 740. The steps 705-740 in the method 700 can be repeated as the player 220 continues to play the game 230 and engages in additional activities and behaviors in order to earn other achievements.

Step 745 in method 700 may also be performed in some cases. Here, the achievement and rewards configuration portal 120 can track and persist the state of an achievement that is being undertaken so that the players can readily see the progress towards earning the achievements that they are working on.

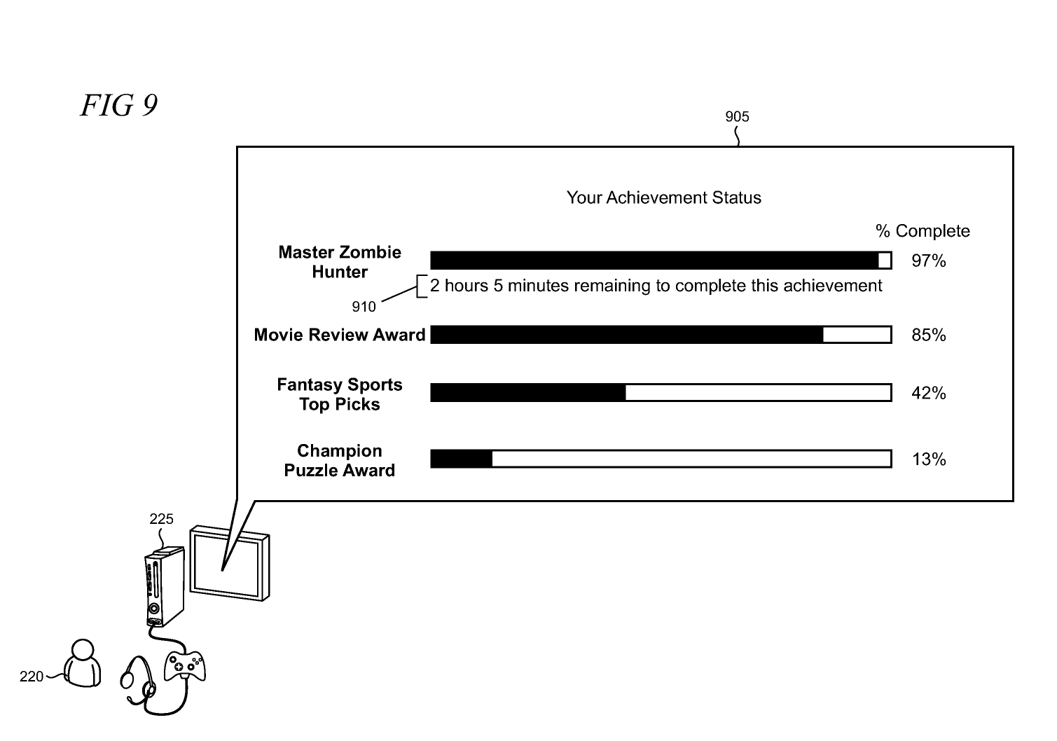

The achievement and rewards configuration portal can then provide achievement status data 820 that may be rendered on a UI on the multimedia console 225. FIG. 9 shows an illustrative UI 905 in which the status of four different achievements is provided for the player 220 across multiple titles. Achievement status may also be tracked and displayed (not shown in FIG. 9) for multiple achievements that are being undertaken by the player in a single title. The achievement status in the illustrative example shown is represented as a percentage of completion for each achievement. In some cases, text and other messages can be displayed in the UI 905 such as the indication 910 that efforts towards a particular achievement are time limited. Achievement status can be provided on demand in response to a player query, or alternatively be displayed when the multimedia console is started up, or when a new game or app is launched, for example.

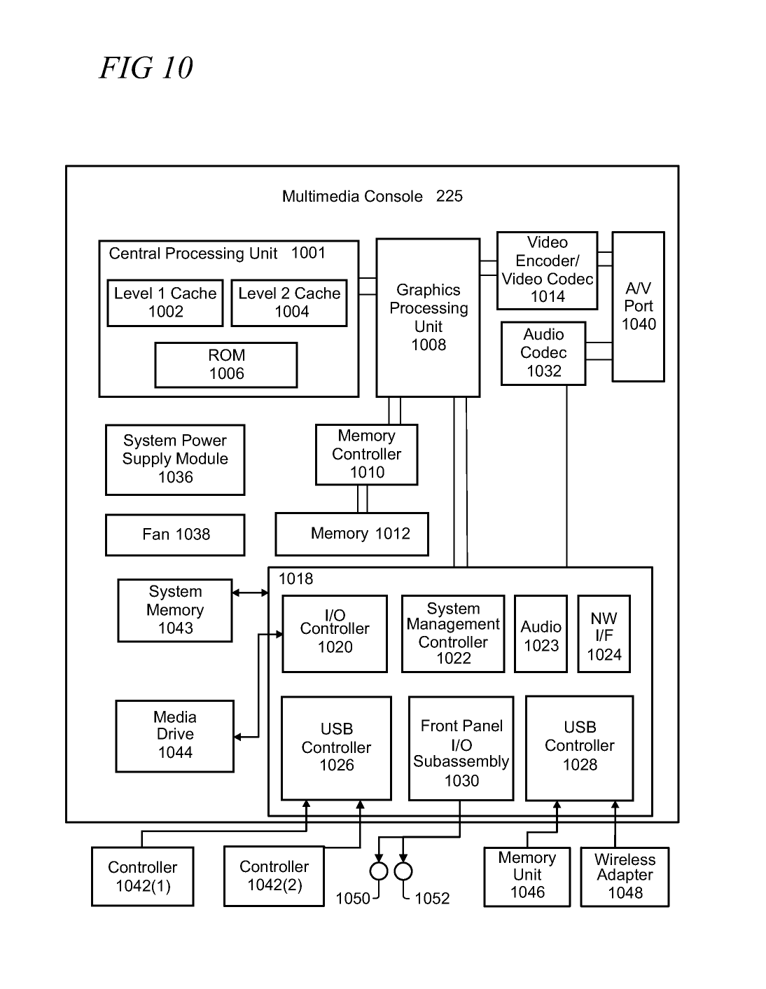

FIG. 10 is an illustrative functional block diagram of the multimedia console 225 shown in FIGS. 2, 6, 8, and 9. As shown in FIG. 10, the multimedia console 225 has a central processing unit (CPU) 1001 having a level 1 cache 1002, a level 2 cache 1004, and a Flash ROM (Read Only Memory) 1006. The level 1 cache 1002 and the level 2 cache 1004 temporarily store data and hence reduce the number of memory access cycles, thereby improving processing speed and throughput. The CPU 1001 may be configured with more than one core, and thus, additional level 1 and level 2 caches 1002 and 1004. The Flash ROM 1006 may store executable code that is loaded during an initial phase of a boot process when the multimedia console 225 is powered ON.

A graphics processing unit (GPU) 1008 and a video encoder/video codec (coder/decoder) 1014 form a video processing pipeline for high speed and high resolution graphics processing. Data is carried from the GPU 1008 to the video encoder/video codec 1014 via a bus. The video processing pipeline outputs data to an A/V (audio/video) port 1040 for transmission to a television or other display. A memory controller 1010 is connected to the GPU 1008 to facilitate processor access to various types of memory 1012, such as, but not limited to, a RAM.

The multimedia console 225 includes an I/O controller 1020, a system management controller 1022, an audio processing unit 1023, a network interface controller 1024, a first USB (Universal Serial Bus) host controller 1026, a second USB controller 1028, and a front panel I/O subassembly 1030 that are preferably implemented on a module 1018. The USB controllers 1026 and 1028 serve as hosts for peripheral controllers 1042(1)-1042(2), a wireless adapter 1048, and an external memory device 1046 (e.g., Flash memory, external CD/DVD ROM drive, removable media, etc.). The network interface controller 1024 and/or wireless adapter 1048 provide access to a network (e.g., the Internet, home network, etc.) and may be any of a wide variety of various wired or wireless adapter components including an Ethernet card, a modem, a Bluetooth module, a cable modem, or the like.

System memory 1043 is provided to store application data that is loaded during the boot process. A media drive 1044 is provided and may comprise a DVD/CD drive, hard drive, or other removable media drive, etc. The media drive 1044 may be internal or external to the multimedia console 225. Application data may be accessed via the media drive 1044 for execution, playback, etc. by the multimedia console 225. The media drive 1044 is connected to the I/O controller 1020 via a bus, such as a Serial ATA bus or other high speed connection (e.g., IEEE 1394).

The system management controller 1022 provides a variety of service functions related to assuring availability of the multimedia console 225. The audio processing unit 1023 and an audio codec 1032 form a corresponding audio processing pipeline with high fidelity and stereo processing. Audio data is carried between the audio processing unit 1023 and the audio codec 1032 via a communication link. The audio processing pipeline outputs data to the A/V port 1040 for reproduction by an external audio player or device having audio capabilities.

The front panel I/O subassembly 1030 supports the functionality of the power button 1050 and the eject button 1052, as well as any LEDs (light emitting diodes) or other indicators exposed on the outer surface of the multimedia console 225. A system power supply module 1036 provides power to the components of the multimedia console 225. A fan 1038 cools the circuitry within the multimedia console 225.

The CPU 1001, GPU 1008, memory controller 1010, and various other components within the multimedia console 225 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 225 is powered ON, application data may be loaded from the system memory 1043 into memory 1012 and/or caches 1002 and 1004 and executed on the CPU 1001. The application may present a graphical user interface that provides a consistent user experience when navigating to different media types available on the multimedia console 225. In operation, applications and/or other media contained within the media drive 1044 may be launched or played from the media drive 1044 to provide additional functionalities to the multimedia console 225.

The multimedia console 225 may be operated as a standalone system by simply connecting the system to a television or other display. In this standalone mode, the multimedia console 225 allows one or more users to interact with the system, watch movies, or listen to music. However, with the integration of broadband connectivity made available through the network interface controller 1024 or the wireless adapter 1048, the multimedia console 225 may further be operated as a participant in a larger network community.

When the multimedia console 225 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbps), etc. Because these resources are reserved at system boot time, the reserved resources do not exist from the application's view.

In particular, the memory reservation preferably is large enough to contain the launch kernel, concurrent system applications, and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render pop-ups into an overlay. The amount of memory needed for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV re-sync is eliminated.

After the multimedia console 225 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 1001 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 1042(1) and 1042(2)) are shared by gaming applications and system applications. The input devices are not reserved resources, but are to be switched between system applications and the gaming application such that each will have a focus of the device. The application manager preferably controls the switching of input stream, without knowledge of the gaming application's knowledge and a driver maintains state information regarding focus switches.

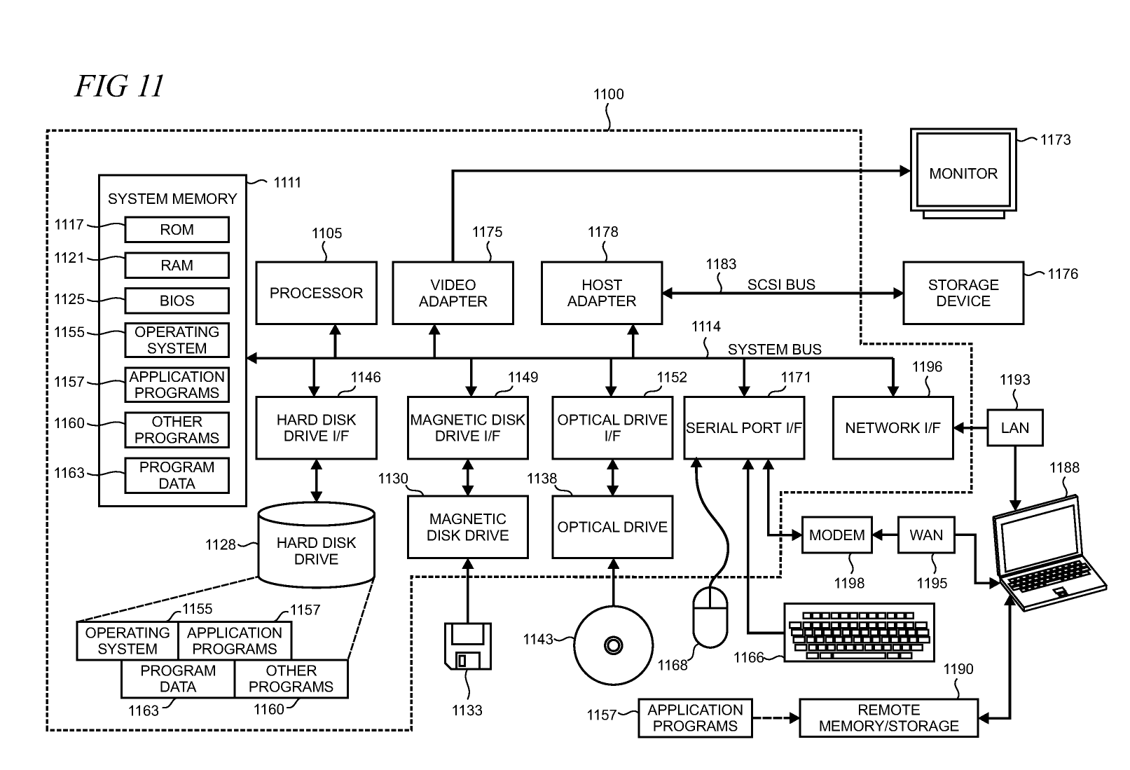

FIG. 11 is a simplified block diagram of an illustrative computer system 1100 such as a PC, client device, or server with which the present time limited, application spanning and post-application release achievements may be implemented. Computer system 1100 includes a processing unit 1105, a system memory 1111, and a system bus 1114 that couples various system components including the system memory 1111 to the processing unit 1105. The system bus 1114 may be any of several types of bus structures including a memory bus or memory controller, a peripheral bus, and a local bus using any of a variety of bus architectures. The system memory 1111 includes read only memory (“ROM”) 1117 and random access memory (“RAM”) 1121. A basic input/output system (“BIOS”) 1125, containing the basic routines that help to transfer information between elements within the computer system 1100, such as during startup, is stored in ROM 1117. The computer system 1100 may further include a hard disk drive 1128 for reading from and writing to an internally disposed hard disk (not shown), a magnetic disk drive 1130 for reading from or writing to a removable magnetic disk 1133 (e.g., a floppy disk), and an optical disk drive 1138 for reading from or writing to a removable optical disk 1143 such as a CD (compact disc), DVD (digital versatile disc), or other optical media. The hard disk drive 1128, magnetic disk drive 1130, and optical disk drive 1138 are connected to the system bus 1114 by a hard disk drive interface 1146, a magnetic disk drive interface 1149, and an optical drive interface 1152, respectively. The drives and their associated computer readable storage media provide non-volatile storage of computer readable instructions, data structures, program modules, and other data for the computer system 1100. Although this illustrative example shows a hard disk, a removable magnetic disk 1133, and a removable optical disk 1143, other types of computer readable storage media which can store data that is accessible by a computer such as magnetic cassettes, flash memory cards, digital video disks, data cartridges, random access memories (“RAMs”), read only memories (“ROMs”), and the like may also be used in some applications of the present time limited, application spanning and post-application release achievements. In addition, as used herein, the term computer readable storage medium includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 1133, optical disk 1143, ROM 1117, or RAM 1121, including an operating system 1155, one or more application programs 1157, other program modules 1160, and program data 1163. A user may enter commands and information into the computer system 1100 through input devices such as a keyboard 1166 and pointing device 1168 such as a mouse. Other input devices (not shown) may include a microphone, joystick, game pad, satellite dish, scanner, trackball, touchpad, touch screen, touch-sensitive module or device, gesture-recognition module or device, voice recognition module or device, voice command module or device, or the like. These and other input devices are often connected to the processing unit 1105 through a serial port interface 1171 that is coupled to the system bus 1114, but may be connected by other interfaces, such as a parallel port, game port, or USB. A monitor 1173 or other type of display device is also connected to the system bus 1114 via an interface, such as a video adapter 1175. In addition to the monitor 1173, personal computers typically include other peripheral output devices (not shown), such as speakers and printers. The illustrative example shown in FIG. 11 also includes a host adapter 1178, a Small Computer System Interface (“SCSI”) bus 1183, and an external storage device 1176 connected to the SCSI bus 1183.

The computer system 1100 is operable in a networked environment using logical connections to one or more remote computers, such as a remote computer 1188. The remote computer 1188 may be selected as another personal computer, a server, a router, a network PC, a peer device, or other common network node, and typically includes many or all of the elements described above relative to the computer system 1100, although only a single representative remote memory/storage device 1190 is shown in FIG. 11. The logical connections depicted in FIG. 11 include a local area network (“LAN”) 1193 and a wide area network (“WAN”) 1195. Such networking environments are often deployed, for example, in offices, enterprise-wide computer networks, intranets, and the Internet.

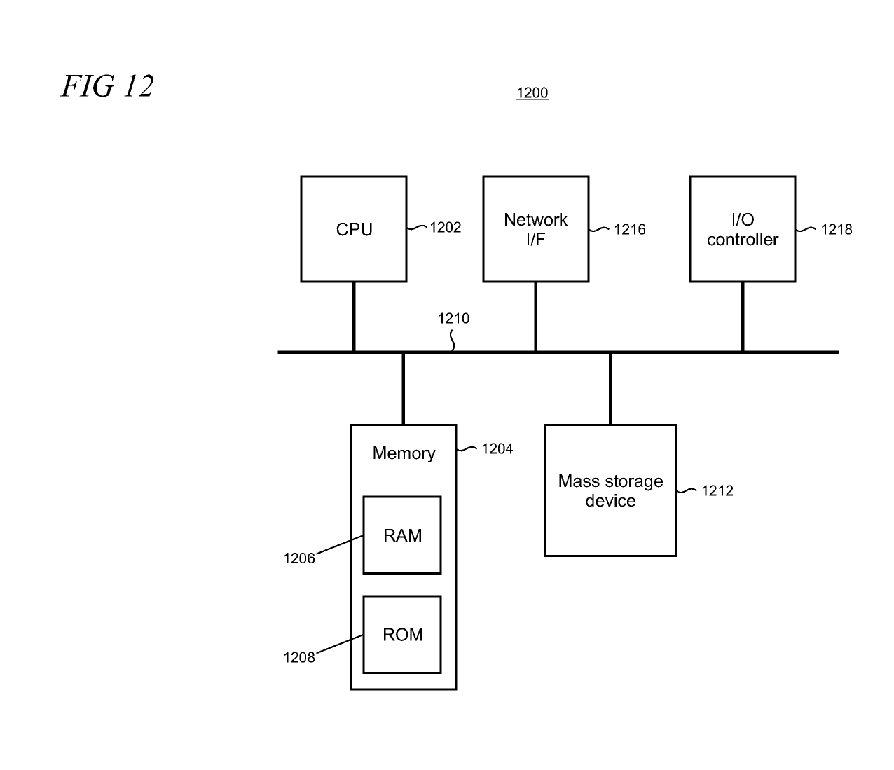

When used in a LAN networking environment, the computer system 1100 is connected to the local area network 1193 through a network interface or adapter 1196. When used in a WAN networking environment, the computer system 1100 typically includes a broadband modem 1198, network gateway, or other means for establishing communications over the wide area network 1195, such as the Internet. The broadband modem 1198, which may be internal or external, is connected to the system bus 1114 via a serial port interface 1171. In a networked environment, program modules related to the computer system 1100, or portions thereof, may be stored in the remote memory storage device 1190. It is noted that the network connections shown in FIG. 11 are illustrative and other means of establishing a communications link between the computers may be used depending on the specific requirements of an application of time limited, application spanning and post-application release achievements. It may be desirable and/or advantageous to enable other types of computing platforms other than the multimedia console 225 to implement the present time limited, application spanning and post-application release achievements in some applications. For example, a player statistics logging client may be readily adapted to run on various fixed computing platforms and mobile computing platforms. FIG. 12 shows an illustrative architecture 1200 for a computing platform or device capable of executing the various components described herein for time limited, application spanning and post-application release achievements. Thus, the architecture 1200 illustrated in FIG. 12 shows an architecture that may be adapted for a server computer, mobile phone, a PDA (personal digital assistant), a smartphone, a desktop computer, a netbook computer, a tablet computer, GPS (Global Positioning System) device, gaming console, and/or a laptop computer. The architecture 1200 may be utilized to execute any aspect of the components presented herein.

The architecture 1200 illustrated in FIG. 12 includes a CPU 1202, a system memory 1204, including a RAM 1206 and a ROM 1208, and a system bus 1210 that couples the memory 1204 to the CPU 1202. A basic input/output system containing the basic routines that help to transfer information between elements within the architecture 1200, such as during startup, is stored in the ROM 1208. The architecture 1200 further includes a mass storage device 1212 for storing software code or other computer-executed code that is utilized to implement applications, the file system, and the operating system.

The mass storage device 1212 is connected to the CPU 1202 through a mass storage controller (not shown) connected to the bus 1210. The mass storage device 1212 and its associated computer-readable storage media provide non-volatile storage for the architecture 1200. Although the description of computer-readable storage media contained herein refers to a mass storage device, such as a hard disk or CD-ROM drive, it should be appreciated by those skilled in the art that computer-readable media can be any available computer storage media that can be accessed by the architecture 1200.

By way of example, and not limitation, computer-readable storage media may include volatile and non-volatile, removable and non-removable media implemented in any method or technology for storage of information such as computer-readable instructions, data structures, program modules or other data. For example, computer-readable media includes, but is not limited to, RAM, ROM, EPROM (erasable programmable read only memory), EEPROM (electrically erasable programmable read only memory), Flash memory or other solid state memory technology, CD-ROM, DVDs, HD-DVD (High Definition DVD), BLU-RAY, or other optical storage, magnetic cassettes, magnetic tape, magnetic disk storage or other magnetic storage devices, or any other medium which can be used to store the desired information and which can be accessed by the architecture 1200.

According to various embodiments, the architecture 1200 may operate in a networked environment using logical connections to remote computers through a network. The architecture 1200 may connect to the network through a network interface unit 1216 connected to the bus 1210. It should be appreciated that the network interface unit 1216 also may be utilized to connect to other types of networks and remote computer systems. The architecture 1200 also may include an input/output controller 1218 for receiving and processing input from a number of other devices, including a keyboard, mouse, or electronic stylus (not shown in FIG. 12). Similarly, the input/output controller 1218 may provide output to a display screen, a printer, or other type of output device (also not shown in FIG. 12).

It should be appreciated that the software components described herein may, when loaded into the CPU 1202 and executed, transform the CPU 1202 and the overall architecture 1200 from a general-purpose computing system into a special-purpose computing system customized to facilitate the functionality presented herein. The CPU 1202 may be constructed from any number of transistors or other discrete circuit elements, which may individually or collectively assume any number of states. More specifically, the CPU 1202 may operate as a finite-state machine, in response to executable instructions contained within the software modules disclosed herein. These computer-executable instructions may transform the CPU 1202 by specifying how the CPU 1202 transitions between states, thereby transforming the transistors or other discrete hardware elements constituting the CPU 1202.

Encoding the software modules presented herein also may transform the physical structure of the computer-readable storage media presented herein. The specific transformation of physical structure may depend on various factors, in different implementations of this description. Examples of such factors may include, but are not limited to, the technology used to implement the computer-readable storage media, whether the computer-readable storage media is characterized as primary or secondary storage, and the like. For example, if the computer-readable storage media is implemented as semiconductor-based memory, the software disclosed herein may be encoded on the computer-readable storage media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable storage media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the architecture 1200 in order to store and execute the software components presented herein. It also should be appreciated that the architecture 1200 may include other types of computing devices, including hand-held computers, embedded computer systems, smartphones, PDAs, and other types of computing devices known to those skilled in the art. It is also contemplated that the architecture 1200 may not include all of the components shown in FIG. 12, may include other components that are not explicitly shown in FIG. 12, or may utilize an architecture completely different from that shown in FIG. 12.

Based on the foregoing, it should be appreciated that technologies for time limited, application spanning and post-application release achievements have been disclosed herein. Although the subject matter presented herein has been described in language specific to computer structural features, methodological and transformative acts, specific computing machinery, and computer readable storage media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed:

1. A method for enabling achievements to be authored through a portal, comprising the steps of:
configuring the portal for authoring statistics that describe a user's interactions or behaviors with an application during execution on a device, the statistics being logged subsequent to the authoring by a statistics logging client on the device as the application executes on the device; and
configuring the portal for creating an achievement that is awardable to the user, the creating comprising specifying a threshold by which the user earns the achievement when exceeded by the logged statistics;

2. The method of claim 1 in which the creating further comprises specifying criteria for earning the achievement.

3. The method of claim 1 further comprising enabling authoring of a cross-title achievement that is awardable when specified thresholds are exceeded by statistics logged across each of a plurality of application titles.

4. The method of claim 1 further comprising enabling authoring of a cross-platform achievement that is awardable when specified thresholds are exceeded by logged statistics across each of a plurality of different computing platform types.

5. The method of claim 1 further comprising enabling authoring of a post-application ship achievement that is awardable when specified thresholds are exceeded by logged statistics, the post-application ship achievement being separate from any achievement that is implemented using achievement-specific code in the application.

6. The method of claim 1 further comprising enabling authoring of a community achievement that is awardable to each of a plurality of users in an online community when specified thresholds are exceeded by logged statistics across the users in the online community as a whole.

7. The method of claim 6 in which the community achievement is awardable when individual specified thresholds associated with each of the users in the community are also exceeded.

8. The method of claim 1 further comprising enabling authoring of a time window achievement that is awardable when specified thresholds are exceeded by logged statistics that are captured within a specified limited time window.

9. The method of claim 1 further comprising enabling authoring of a social achievement that is awardable when specified thresholds are exceeded by logged statistics across a social graph of a user as a whole.

10. The method of claim 1 further comprising enabling authoring of a meta-game achievement that is awardable when specified thresholds are exceeded by each of a plurality of individual achievements that comprise a meta-game.

11. One or more computer-readable storage media storing instructions which, when executed by one or more processors on an electronic device, perform a method for implementing an achievement in an application executing on the device, comprising:
receiving statistics representative of user interactions with each of a plurality of application titles, the received statistics being logged at devices during execution of each of the applications;
comparing the received statistics against achievement criteria by which an achievement is earned by an application user; and
sending an award notification to the device to inform the application that an award has been earned.

12. The one or more computer-readable storage media of claim 11 further comprising storing the received statistics in a data repository.

13. The one or more computer-readable storage media of claim 12 further comprising generating achievement progress status data using the stored statistics.

14. A system for receiving awarded achievements, comprising:
at least one processor; and
memory operatively coupled to the processor and storing computer-readable instructions that, when executed by the at least one processor, implement a statistics logging client that performs a method comprising the steps of:
capturing statistics representative of a user's interactions with an application, the statistics being captured by the statistics logging client during execution of the application on the system, and
transmitting the captured statistics to a remote service, the remote service comparing the captured statistics against one or more achievement criteria by which an achievement is awardable, the remote service being configured for awarding the achievement through the system to the user when the one or more achievement criteria are satisfied.

15. The system of claim 14 in which the processor and memory are incorporated into a device being one of multimedia console, mobile phone, smartphone, tablet, personal computer (“PC”), personal digital assistant (“PDA”), handheld gaming platform, personal media player, wearable computer, or navigation device.

16. The system of claim 14 in which the statistics logging client is instantiated in the application.

17. The system of claim 14 in which the statistics logging client is instantiated in either an operating system executing on the system or in an application layer executing on the system.

18. The system of claim 14 further including a step of receiving an achievement award notification from the remote service.

19. The system of claim 15 further including a step of receiving metadata associated with a reward, the metadata including one of image of the reward or text that describes the reward.

20. The system of claim 19 further including a step of unlocking a reward associated with the achievement.
